(19) United States
(12) Patent Application Publication
(10) Pub. No.: US 2025/0282551 A1
(43) Pub. Date: Sep. 11, 2025

(54) SYSTEM AND METHOD TO STORE FLUID UNDERGROUND

(71) Applicant: Quidnet Energy, Inc, Houston, TX (US)

(72) Inventors: Dagong Zhou, Houston, TX (US); Bunker Hill, Sugar Land, TX (US)

(21) Appl. No.: 19/071,613

(22) Filed: Mar. 5, 2025

Related U.S. Application Data
(60) Provisional application No. 63/562,553, filed on Mar. 7, 2024.
(60) Provisional application No. 63/641,454, filed on May 2, 2024.

(51) Int. Cl. B65G 5/00; E21B 33/138; E21B 41/00; E21B 43/26; F02C 1/02; F17C 1/00

(52) U.S. Cl. CPC B65G 5/005; E21B 33/138; E21B 41/0057; E21B 43/26; F02C 1/02; F17C 1/007; F05D 2220/76; F17C 2221/033; F17C 2227/0135; F17C 2265/06; F17C 2270/0581

(57) ABSTRACT

A method for storing fluids and waste underground in a subterranean zone and one or more fractures created with a fracture and seal process. This will be useful for oil and gas fields, depleted oil or gas wells, abandoned oil or gas wells, industrial plants, food processing plants, or other fluid or waste storage operations.

### CROSS-REFERENCE TO RELATED APPLICATION

This application claims the benefit of U.S. Provisional Patent Application Nos. 63/562,553 filed Mar. 7, 2024, and 63/641,454 filed May 2, 2024, both of which are hereby incorporated by reference in their entirety herein.

### BACKGROUND OF THE INVENTION

### I. Field of the Invention

The present disclosure relates generally to fluid storage, and more specifically to storage of fuels, other useful fluids and waste underground in subterranean fractures and particularly in fractured and/or sealed rock formations.

### II. Description of the Prior Art

While it is relatively easy for electrical power to move from place to place over long distances, electrical power demand is ever increasing in the United States as it is used, among other things, for lighting, heating, cooling, refrigeration, electronics, machinery, and some transportation systems. Moreover, the frequency of peak power events is increasing as the number of power-hungry devices attached to the North American power transmission grid increases. In the United States, much of the electricity is generated by burning natural gas as a fuel.

It is to be understood that natural gas and oil were formed by millions of years of exposure to heat and pressure applied to organic materials captured in layers under the earth's surface. Natural gas is conventionally moved via pipelines under pressures typically in the range of 500 to 1,400 psi. For such movement, compressor stations are disposed typically every 50 to 100 miles to continually compress and keep the fluid moving in the pipeline. This type of infrastructure is often very expensive, and some type of proximal fuel storage means is often needed to feed the power generation plants.

Natural gas to feed such plants may be stored in salt caverns, depleted oil and gas reservoirs, as well as underground aquifers. There are numerous drawbacks to such storage methods, most important of which is that not all of these storage methods are available near power generation plants, which is desirable for quick fuel delivery and use. One method to supply natural gas quickly to a power plant to meet the demand of a peak power event would be to have a large supply of natural gas stored near the plant. Drawbacks to such methods include the large volume, high-pressure, placement of tanks above and/or below ground.

Consequently, there is a need for an improved method and system for storing natural gas near power plants and other facilities for its near immediate use. Other fluids and fuels could be stored near the facility to shorten delivery time, down time, and eliminate risk thus smoothing out plant output including electricity generation schedules.

Subterranean energy storage is similar to compressed air energy storage (CAES) in that the working fluid is stored underground, however the energy recovery mechanisms are quite different. Both systems can gain some geothermal energy from the earth to warm the working fluid but subterranean energy storage relies on the elasticity of the earth and the overburden on the rock where the working fluid is stored. For this technology any or all fluidically connected parts can be used to store high pressure fluid. The fluid stored may be used as the working fluid for a system to produce electricity or other useful work below ground or above ground.

In the construction phase of the subterranean energy storage system the well, the subterranean zone, and the surface facilities must be built and/or properly prepared for the operation phase. A subterranean zone can be made up of man-made hydraulic fractures, natural fractures, natural occurring caves, or other fluidically connected geologic features. Not all subterranean systems include fractured formations in the subterranean zone. Some are naturally sealed, or confined, and do not require hydraulic fracturing or sealing.

The steps to prepare the zone, fracture, store high pressure fluid in the subterranean zone, and then move it to the surface equipment to perform useful work, desalinate water and generate electricity are described in applicant's earlier granted patents, U.S. Pat. Nos. 8,763,387, 9,481,519, 10,125,035 and 11,927,085, all of which are hereby incorporated by reference in their entirety herein. Also hereby incorporated in their entirety herein are applicants' U.S. Pat. No. 11,795,802 describing the creation of fractures in the subterranean zone, sealing it, and preparing it to store high-pressure working fluids which are later moved to the surface to perform useful work; and U.S. Pat. No. 12,123,293 describing other methods to fracture and seal the subterranean zone prior to utilizing it for storage of the high-pressure working fluid.

Essentially, the first step is to collect and evaluate geologic data. Pilot wells may be drilled to collect various geologic data including core samples to verify models. Once a feasible well placement has been determined, one or more wells are drilled, then one or more casing strings are run and cemented in place. Completions are designed and placed in a manner that allows the working fluid to traverse between the wellbore and subterranean formation with the least restriction. In some instances, it may be necessary to sever the upper casing from the lower casing. There are many methods available today to perform this operation which may include techniques such as perforating, fracturing, water jetting, or others to establish a smooth fluid flow path into and out of the subterranean zone for the working fluid through the wellbore.

After the well is constructed, pressure pumping and fluid mixing equipment are moved to the location. One or more treatment schedules are injected into the target subterranean formation to artificially modify the permeability of the formation. At this time the formation can be sealed, if necessary, and prepared for the operation phase.

It is important to note that the well bore can be vertical, near vertical, horizontal, near horizontal or at any angle. Likewise, the fracture opening or the subterranean zone, or the storage fractures can be vertical, near vertical, horizontal, near horizontal or at any angle relative to the well bore.

During the operation phase, the fluid is injected down the well bore, and out into the subterranean zone. It is stored in the subterranean zone as high-pressure fluid. Fluid is pumped from a low-pressure storage area to a high-pressure subterranean zone where it can be used immediately or stored for a period of time before being moved to the surface. The high-pressure fluid can, for example, be used with a turbine/generator set to produce electricity.

Accordingly, such subterranean energy storage systems may be adapted to store the fuel for the aforementioned power generation plants. Furthermore, while the fluid has thus far been described as a fuel that may be used for a proximal power plant, it will be appreciated that the system may also be utilized to store other useful fluids, waste and even biowaste.

Historically some oil and gas production waste products have been stored underground, these by products include salt water, sludge waste, wastewater, contaminated water, agriculture waste, municipal waste, industrial plant waste, food manufacturing waste, and perhaps other unwanted compounds resulting from such oil and gas production and processing. Older disposal wells have shown issues with ground water contamination, limited injection pressure, limited injection volume, leaks to the surface, corrosion, and limited storage volume.

In any event, it is a general object of the present disclosure to provide a system and method to store fluids underground.

It is another general object of the present disclosure to provide a system and method to store fluids underground and proximal to a power plant.

It is yet another general object of the present disclosure to provide a system and method to store other useful fluids underground.

Yet a further object of the present disclosure is to provide a system and method to store waste underground.

Still another object of the present disclosure is to provide a system and method to store chemically reacted waste underground that forms a compound.

And another object of the present disclosure is to provide a system and method to store carbon rich slurries for carbon sequestration.

These and other objects, features and advantages of this disclosure will be clearly understood through a consideration of the following detailed description.

### SUMMARY OF THE INVENTION

According to an embodiment of the present disclosure, there is provided a system for the storage of fluid within a subterranean area. One or more zones are adapted to receive the fluid via hydraulic fracturing and sealing. A facility pumps and retains the fluid in the zones for a period of time.

According to an embodiment of the present disclosure, there is also provided a method for the storage of fluid including selecting a subterranean area, adapting the area via fracturing and sealing the zones, and pumping and retaining the fluid in the zones for a period of time.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified schematic view of a subterranean fluid storage system according to the principles of an embodiment of the present disclosure.

FIG. 2 is a simplified schematic view of a fractured and sealed subterranean zone used for storage of fluid according to the principles of an embodiment of the present disclosure.

FIG. 3 is a simplified schematic view of a subterranean fluid storage system and generator according to the principles of an embodiment of the present disclosure.

FIG. 4 is a simplified block diagram of the fluid flow out of the subterranean to the surface facility where the energy, stored as pressure might be used to perform useful work turning a turbine/generator set and/or delivering fuel to a combustion process according to the principles of an embodiment of the present disclosure.

FIG. 5 is a simplified schematic view of a fractured and sealed subterranean zone with sealing material along the rock face used for storage of fluid according to the principles of an embodiment of the present disclosure

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

It is to be understood that hydraulic fracturing is a process used in oil and gas wells for pumping fluids and solids through a wellbore and out into a zone breaking open rock to provide paths for hydrocarbons to move into the well and up to the surface. In this storage application method and system, the fractured zone may have a larger volume and a higher pressure applied to the fuel or other fluid being stored. In an embodiment, a method includes drilling a well to a target depth and fracturing and sealing the zone. A desired subterranean zone is thereby created in which to hold fuel or other fluids at high pressure for long or short durations.

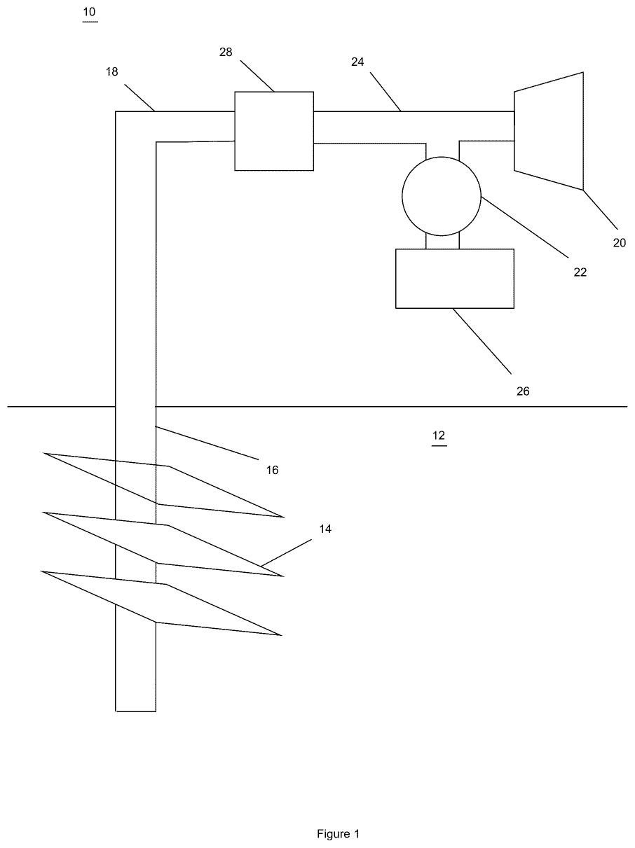

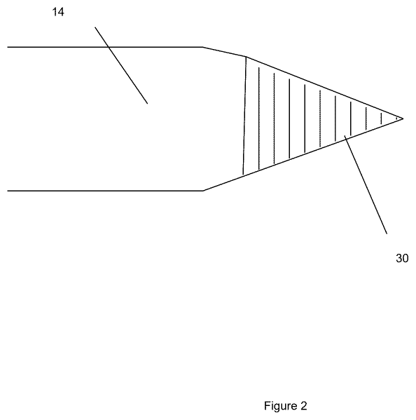

FIGS. 1 and 2 illustrates an embodiment of a method and system 10 for storing fluid underground for use in a power plant or any other facility that desires the fluid. In this embodiment, the fluid is fuel. The fuel may be natural gas and/or any other desired fluid that may be used as a fuel. As shown, a subterranean area 12 with fractured and sealed subterranean zones 14 is connected to a wellbore 16 connected to a gas line 18 that is connected to a turbine 20 and/or combustion chamber. Inputs are air and natural gas, and outputs are waste heat and electricity.

The method and system may include injecting a fluid through a wellbore 16 into one or more subterranean areas 12, storing the fluid in the one or more fractured and sealed subterranean zones 14, and allowing the fluid to pass through a valve 22, and flow through a conduit 24 from the one or more subterranean zones to a desired location 26, which may be above or below surface. The fluid may be a fuel (i.e., natural gas and/or any other desired fluid that may be used as a fuel). The desired location 26 may be a power plant or any other location to which the fluid is desired.

The method includes selecting a location and selecting one or more subterranean zones 12 at the location. A well is then drilled at the one or more subterranean zones. Fracturing the one or more subterranean zones of interest may be accomplished with fracturing fluids, which may or may not include proppant and/or other solid materials. Fractures and/or the rock pores are then sealed. It is to be understood that sealing the fractured subterranean zone may be done with common oil field materials. US granted patent U.S. Pat. No. 12,123,293 discloses some of such methods, which is incorporated by reference herein in its entirety. The sealing materials may be pumped with the fracturing treatment or in subsequent steps. The method further includes removing some, none, or all of the fracturing fluids. Moreover, the method includes injecting the desired fluid (i.e., the fuel or another fluid to be stored) into the one or more subterranean zones. The fluid is held in the one or more subterranean zones under pressure. At the end of the desired storage period, the valve 22 or valves are opened, which may allow the fluid to flow to the desired location 26 (i.e., power plant). When fluids are pumped or moved via an above or below surface station or facility 28, some processing may be needed within that station to filter, remove contaminants, and/or remove water from the fluids.

A large amount of energy may be used to compress the fluid as it is pumped into the one or more subterranean zones and fractures. Such pressure may be converted to mechanical work when the fluid returns to the surface. Some of such pressure may be used to produce electricity. For instance, the pressure may be used to generate electricity by turning a shaft on a generator prior to delivering the fuel to the combustion chamber 20 (i.e., of the power plant or other desired location). If the pressure is too small, then it may not be converted mechanically, and the fluid (i.e., fuel such as natural gas) may be delivered to the combustion chamber/turbine 20 as shown in FIG. 1. Alternatively, the high-pressure fuel may be delivered to the combustion chamber without reduction to increase the system output.

In one embodiment, the method and system store natural gas for an on-site fuel supply for power plants. A fracture is created. Sealants 30 and/or proppants are injected into the fracture. Fuel is then injected, or desired amounts of fluids are produced out of the fracture and then the fuel is injected. Fuel is then produced from the fracture.

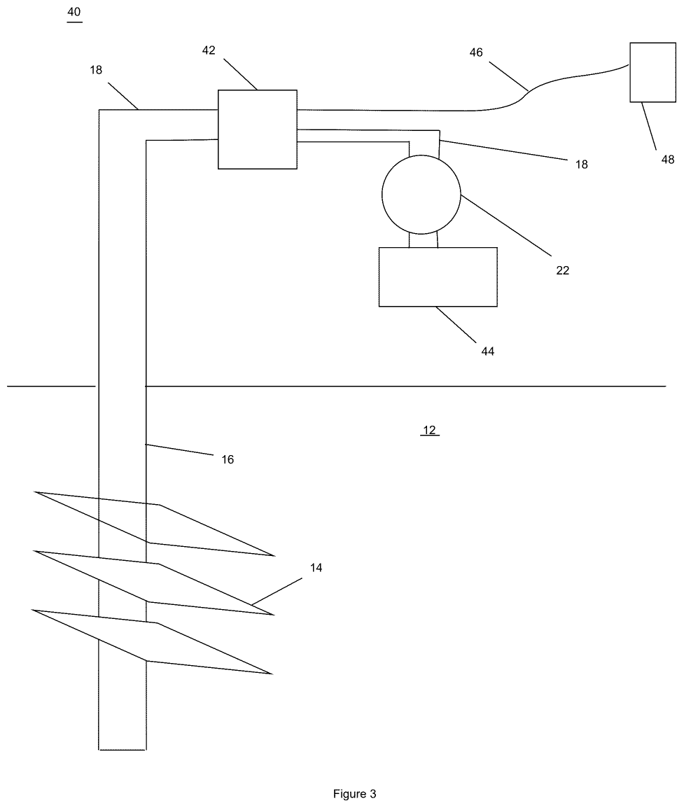

Turning now to a preferred embodiment of the present disclosure, and in particular FIG. 3. The system 40 includes a well 16, a subterranean zone 12, a surface facility 42 which may include a turbine/generator, a mechanism 44 for working fluid storage, and an electrical path 46 to end users 48.

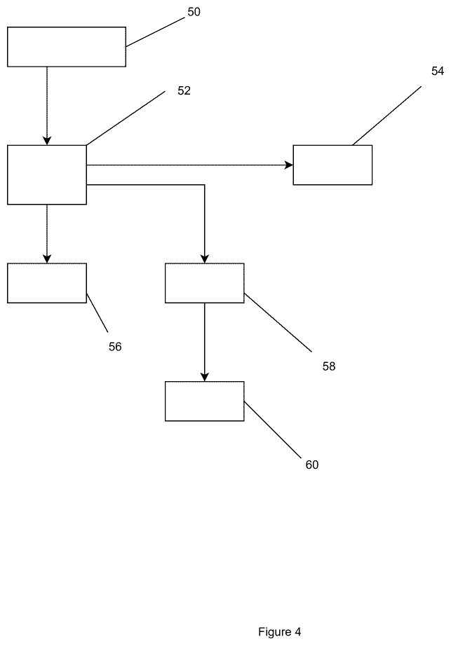

Block diagram FIG. 4 depicts the high-pressure fuel 50 flow from the subterranean storage to the surface to the turbine/generator set 52 where some of the stored energy as fluid pressure is used to spin a turbine/generator 52 to output electricity 56. The other flow path shows the fuel exiting the turbine/generator set 52 and routed to the pump 54 to be reinjected into the subterranean zone. The third path describes fuel leaving the turbine/generator 52 at a lower pressure to a combustion chamber 58 where it can be burned to generate electricity 60 or to create heat or another form of useful work.

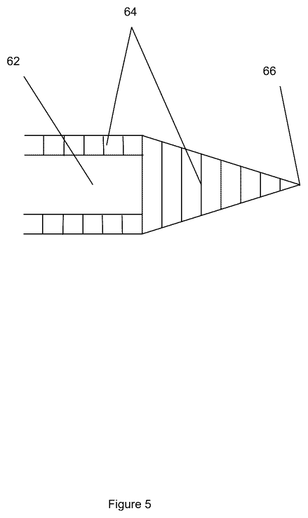

Fractured and sealed subterranean zones will eliminate or reduce the severity of the failure mechanisms experience with disposal wells. New wells and new fractured and sealed subterranean zones can be used or existing wells and with new fractured and sealed subterranean zones can be utilized. Combinations of old and new wells and/or old existing fractured and sealed subterranean zones can be utilized. This will allow repurposing existing oil and gas wells, abandoned wells, water wells, and/or low production wells. FIG. 5 depicts the storage volume 52 inside the seal material 64 also shown in the fracture tip 56. The seal material 64 may cover all rock surfaces or it may only plug the rock pores and/or the fracture tip 56.

Other uses are for this method and system include pipelines 24 as underground storage, which may replace a portion of the pipe storage volume in some designs. Refineries may also use this method and system for fuel or other fluids that are stored. In other embodiments, large scale transportation facilities may use this location to store fuel or other fluids that are to be consumed by the transportation vehicle or to be transported from one location to another.

Fuel can be stored in order to supplement a supply pipeline during periods of peak demand or the subterranean zone can be the primary source of fuel supply. The fuel can be stored under high-pressure and move from the subterranean zone, up the well bore to the surface piping and over to the turbine/generator set where the pressure is used to spin the turbine and generator in order to perform some useful work. The useful work will most likely be generating electricity. After exiting the turbine the fuel can be burned in a traditional hydrocarbon electricity generating method or the fuel can be captured and re-injected into the subterranean zone where it could be used to start the cycle again. The fuel can consist of hydrocarbon containing gases, natural gas, or other fluids.

The system and method of the present disclosure can also be applied to waste product storage. This involves fracturing and sealing a subterranean zone 14 which is fluidically connected to one or more well bores 16. After the subterranean zones are properly prepared, fractured, tested and sealed 30 they can be used for energy storage, fluid storage, or waste storage. Fluids, water, or waste materials can be safely injected and stored for short term, long term or never recovered or disturbed. Fracturing and sealing techniques have been developed for storing high pressure fluid as energy which can be later used to perform usable work or electricity production. Many of these new techniques can be applied to injection wells and/or disposal wells which store waste. Waste material can be pumped into one or more subterranean zones that have been fractured and sealed. This would reduce the risk of zone leaks, water contamination, and some of the other problems experienced by disposal wells. Further, a useful chemical compound produced by waste stored and degraded over time or a combination of waste and other chemical reactants mixed with the waste in order to produce a valuable chemical compound such as methane or some variant of alcohol may be produced. If storing waste material, the chemical contents stored in the subterranean zone could be a chemical that reacts with the materials being injected. This reaction could be designed to eliminate, neutralize, or reduce the hazard of the stored material. The product of such reactions could be stored or retrieved after a short time period or an extended period. The chemical reaction in the subterranean zone might be designed so that one by-product is useful, like a fuel or a high value commodity. A couple examples include methane or some variant of an alcohol. This by product can be stored for a period of time or brought to the surface.

This new method involves fracturing and sealing a subterranean zone which is fluidically connected to one or more well bores. Fluids, water, or waste materials can be safely injected and stored for short term, long term or never recovered or disturbed. Fracturing and sealing techniques have been developed for storing high pressure fluid as energy which can be later used to perform usable work or electricity production. Many of these new techniques can be applied to injection wells and/or disposal wells which store waste.

Monitoring of the well, surface facilities, and the subterranean zones can be done with conventional data acquisition equipment which might include, but is not limited to tiltmeters, InSAR, pressure and temperature gauges and transducers, flow meters, floats, distance measurement devices, down hole temperature, pressure flow rate, fiber optic means, seismic, etc. Modern control techniques including SCADA, software, reporting, dashboards, communications, security, etc. might be utilized for surface and subsurface.

Benefits of this new fracture and sealing techniques will enable better protection of underground aquifers some of which might be used for human or animal consumption or agriculture. The sealing step will help to ensure that the undesirable mixing of materials injected and subsurface water, oil, or gas.

Oil and gas fields could utilize this new waste storage technology to temporarily or permanently store produced water, saltwater or other waste materials that would impose a cost penalty for transportation or other storage methods or processing.

The method may include fracturing and sealing the one or more subterranean zones prior to storage in a desired location at a desired distance from a desired destination and includes injecting the fuel or other fluids into the one or more subterranean zones for storage. In addition, the method includes allowing the fuel or other fluids to flow under pressure from the one or more subterranean zones to the desired destination at a desired time. The method further includes converting into electricity at least a portion of the pressure produced when allowing the fuel or other fluids to flow. Moreover, the method includes that the converting into electricity step comprises a mechanical means of turning a shaft on a generator. Additionally, the method includes delivering the fuel or other fluids with a lower pressure to a combustion chamber and turbine.

The chemical contents stored in the subterranean zone could be mixed by storing one, most likely the waste and injecting another chemical compound. This reaction could be designed to eliminate, neutralize, or reduce the hazard of the stored material. The product of such reactions could be stored or retrieved after a short time period or an extended period. The chemical reaction in the subterranean zone might be designed so that one by-product is useful, like a fuel or a high value commodity. A couple examples include methane or some variant of alcohol. This by product can be stored for a period of time or brought to the surface at any time. The waste material and/or the reactant material can be pumped into the subterranean zone at the same time or each one can be pumped one at a time.

It will be appreciated that a further utilization of the system and method is adaptation of a carbon rich slurry as the fluid. This may be particularly advantageous in the carbon sequestration field. More specifically, both geological sequestration and technical sequestration techniques will benefit from this capture and storage systema and method.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A system for the subterranean storage of fluid, the system comprising:
a subterranean area for fluid storage;
one or more zones within said area adapted to receive and retain said fluid;
said one or more zones being hydraulically fractured and sealed;
a facility to pump and retain said fluid in said one or more zones; and
said storage of said fluid having a period of time.

2. The system as defined in claim 1 wherein said fluid is a fuel.

3. The system as defined in claim 2 wherein said area is proximal to a power plant.

4. The system as defined in claim 3 wherein at least a portion of said fuel is burned at said plant.

5. The system as defined in claim 1 wherein at least a portion of said fluid is under pressure and is released to generate useful work.

6. The system as defined in claim 1 wherein said time is indefinite.

7. The system as defined in claim 1 wherein said fluid is waste.

8. The system as defined in claim 7 wherein said waste is capable of producing a collectable compound from a chemical reaction within said one or more zones.

9. The system as defined in claim 1 wherein said fluid is a carbon rich slurry.

10. A method for subterranean storage of fluid, the method comprising:
selecting a subterranean area for fluid storage;
adapting one or more zones within said area to receive and retain said fluid;
fracturing and sealing said one or more zones;
pumping and retaining said fluid in said one or more zones; and
storing said fluid for a period of time.

11. The method as defined in claim 10 further comprising burning at least a portion of said fluid at a power plant proximal to said area.

12. The method as defined in claim 10 further comprising generating useful work from at least a portion of said fluid wherein said fluid is under pressure.

13. The method of 10 further comprising producing a collectable compound from a chemical reaction of said fluid within said one or more zones.

14. The method of claim 10 further comprising sequestrating of carbon.
